(19) United States
(12) Patent Application Publication
(10) Pub. No.: US 2010/0136987 A1
(43) Pub. Date: Jun. 3, 2010

(54) WIRELESS COMMUNICATION SYSTEM WITH PROTOCOL ARCHITECTURE FOR IMPROVING LATENCY

(75) Inventors: Kang-Hee Kim, Daejeon (KR); Soo-Jung Jung, Daejeon (KR); Geon-Min Yeo, Daejeon (KR); Soon-Yong Lim, Daejeon (KR); Kyung-Seok Lee, Daejeon (KR); Jae-Heung Kim, Daejeon (KR); Il-Soon Jang, Daejeon (KR); Hyun-Hwa Seo, Daejeon (KR); Jung-Im Kim, Daejeon (KR); Mu-Yong Shin, Daejeon (KR); Byung-Han Ryu, Daejeon (KR)

Correspondence Address: Muncy, Geissler, Olds & Lowe, PLLC, 4000 Legato Road, Suite 310, FAIRFAX, VA, 22033, US

(73) Assignee: Electronics and Telecommunications Research Institute, Daejeon (KR)

(21) Appl. No.: 11/917,413

(22) PCT Filed: Jun. 15, 2006
(86) PCT No.: PCT/KR2006/002294

§ 371 Date: Dec. 13, 2007

(30) Foreign Application Priority Data
Jun. 15, 2005 (KR) 10-2005-0051620

(51) Int. Cl. H04W 72/00

(52) U.S. Cl. 455/450

(57) ABSTRACT

The present invention relates to a wireless communication system having protocol architecture for reducing latency of a cellular system. In the protocol architecture of the wireless communication system in the cellular system, a physical layer supports wireless transmission of the cellular system and estimates a radio channel condition. A data link layer determines a data transmission mode based on a QoS of user data and the radio channel condition estimated by the physical layer and performs segmentation and assembly of the packet data, and a network layer establishes and releases a radio bearer for transmitting packet data transmitted from the data link layer and a control command. A control service access point is provided for control information transmission between the data link layer and the physical layer.

### DESCRIPTION OF DRAWINGS

FIG. 1 is a schematic view of a cellular system according to an exemplary embodiment of the present invention.

FIG. 2 shows protocol architecture of a cellular system according to the exemplary embodiment of the present invention.

FIG. 3 shows a protocol stack in a control plane of a wireless communication system of the cellular system according to the exemplary embodiment of the present invention.

FIG. 4 shows a protocol stack in a user plane of a wireless communication system of the cellular system according to the exemplary embodiment of the present invention.

FIG. 5 shows mapping between a logical channel and a transport channel in the cellular system according to the exemplary embodiment of the present invention.

### BACKGROUND ART

The present invention relates to a wireless communication system having protocol architecture for improving latency in a cellular system.

A Universal Mobile Telecommunication Service (UMTS), which is a third generation mobile communication, is based on a Global System for Mobile Communication (GSM) and a General Packet Radio Service (GPRS). However, unlike the GSM that uses Time Division Multiple Access (TDMA), the UMTS uses Wideband Code Division Multiple Access (WCDMA) and provides a consistent set of services such as packet-based text, digitalized voice or video data, and multimedia data with a high speed data rate over 2 Mbps to a user no matter where the user is located in the world. The UMTS uses a concept of a virtual connection, such as a packet-switched connection using a packet protocol such as the Internet Protocol (IP), so that the virtual connection is always available to any other end point in the network. Standardization work for the UMTS is being carried out by the Third Generation Partnership Project (3GPP). The UMTS uses a Global System for Mobile Communication based mobile application part (GSM-MAP) as a core network, and utilizes an asynchronous network scheme as an air interface since synchronization between base stations is not required.

A conventional cellular system includes a core network and at least one radio network sub-system, and a series of radio network sub-systems connected to each other through an interface forms a radio access network (RAN). Such a RAN is connected to the core network, and the radio network sub-system includes a radio resource controller and at least one base station controlled by the radio resource controller. Each base station serves at least one cell, and a terminal in the cell can access the RAN through the corresponding base station. When the cellular system is the UMTS of the 3GPP, a RAN is provided as a UMTS terrestrial radio access network (UTRAN), and a radio resource controller is provided as a radio network controller (RNC) and a base station is provided as a Node-B. In addition, a terminal may be provided as user equipment formed of a UMTS subscriber identity module and mobile equipment. The core network includes a serving GPRS support node (SGSN) and a gateway GPRS support node (GGSN). The SGSN is connected to the radio resource controller of the radio network sub-system through the interface, and the GGSN supports connection between the SGSN and an external packet network or an Internet.

In such a 3G mobile communication system, each node that forms the terminal, the core network, and the UMTS supports the same protocol layer for data transmission, and a protocol with conventional architecture performs segmentation and reassembly without considering a radio channel condition and thus the amount of unnecessary information to be inserted to a header of a medium access control (MAC) frame is increased, thereby causing radio resource waste in the air interface.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a wireless communication system having protocol architecture that enables an efficient use of radio resources in a radio interface of a cellular system, and a method thereof.

### Technical Solution

An exemplary wireless communication system according to an embodiment of the present invention includes a network layer for receiving user data from an upper layer, a data link layer for determining a data transmission mode on the basis of a quality of service (QoS) of the user data and segmenting the user data into a plurality of packet data, a physical layer for transmitting the plurality of packet data to a radio channel, and a control service access point for transmitting control information between the data link layer and the physical layer.

At this time, the network layer may manage radio resource allocation and the physical layer may transmit the plurality of packet data through an allocated resource among radio resources.

In addition, the data link layer may manage shared resource distribution among the radio resources, and the physical layer may transmit the plurality of packet data through a distributed resource among the shared resources.

The data link layer may also manage the shared resource distribution on the basis of a QoS required for the user data.

A wireless communication system according to another embodiment of the present invention includes a physical layer for receiving a plurality of packet data from a radio channel and estimating a condition of the radio channel, a data link layer for assembling the plurality of received packet data, a network layer for providing the assembled packet data to upper layers, and a control service access point for transmitting control information between the data link layer and the physical layer.

At this time, the network layer may perform selection or combination when the network layer receives a plurality of duplicate packet data that have been assembled in the data link layer from the data link layer due to an occurrence of handover.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. The drawings and description are to be regarded as illustrative in nature and not restrictive, and like reference numerals designate like elements throughout the specification.

Throughout this specification and the claims which follow, unless explicitly described to the contrary, the word “comprising” or variations such as “comprises” will be understood to imply the inclusion of stated elements but not the exclusion of any other elements.

A protocol layer configuration method of a cellular system and a communication device having the protocol layer according to an exemplary embodiment of the present invention will now be described in more detail.

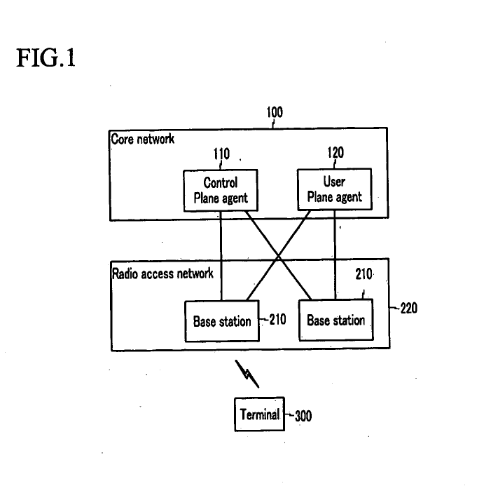

FIG. 1 is a schematic view of a cellular system according to an exemplary embodiment of the present invention.

As shown in FIG. 1, the cellular system according to the exemplary embodiment of the present invention includes a core network 100 and at least one radio access network 200. The core network 100 includes a control plane agent 110 and a user plane agent 120. The radio access network 200 is connected to the core network 100, and includes at least one base station 210. A plurality of base stations 210 in the radio access network 200 may be connected to each other through an interface. Each base station 210 serves at least one cell (not shown), and a terminal 300 in the cell may access the radio access network 200 through the base station 210.

The control plane agent 110 manages access between the terminal 300 and the radio access network 200 and controls radio resources such as radio bearer establishment. The control plane agent 110 includes all the functions that used to be performed in a control plane of a serving GPRS support node (SGSN), and also performs mobility management, logical link management, authorization, authentication, and charging a rate. Further, the control plane agent 110 manages mobility of a terminal in a connected mode. The management of mobility of the terminal in the connected mode used to be performed by a radio resource control (RRC) layer in a conventional cellular system. That is, the control plane agent 110 manages a radio resource allocated to the terminal 300 in the connected mode, manages mobility of the terminal 300, and transmits control signals of a core network 100 to the terminal 300. At this time, the base station 200 transparently transmits the mobility management control signals transmitted from the control plane agent 100 to the terminal 300.

The user plane agent 120 connects the core network 100 and the radio access network 200, transmits user data, and handles data packet exchange with the terminal 300 within a service area. The user plane agent 120 includes all the functions of a gateway GPRS support node (GGSN) and all the functions performed in a user plane of an SGSN, and converts GPRS packets transmitted from the terminal 300 through the radio access network 200 into a packet data protocol (PDP) and transmits the PDP.

The base station 210 includes all the functions of a wireless network controller (RNC) and a Node-B.

According to the exemplary embodiment of the present invention, the control plane agent 110 and the user plane agent 120 of the core network 100 are separated from each other, but they can be integrated into one constituent element of the core network 100.

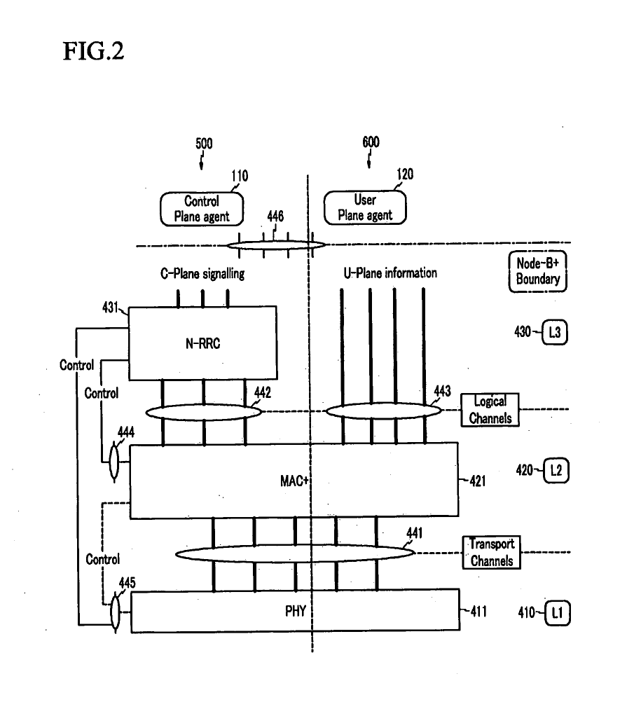

FIG. 2 shows protocol architecture of the cellular system according to the exemplary embodiment of the present invention. The protocol architecture of FIG. 2 may be applied to the base station 210 and the terminal 300 of the cellular system. Protocol architecture applied to the base station 210 will now be described.

As shown in FIG. 2, protocol architecture applied to the base station 210 includes a physical layer (L1) 410, a data link layer (L2) 420, and a network layer (L3) 430, and is broadly divided into a control plane 500 and a user plane 600. In addition, the protocol architecture according to the exemplary embodiment of the present invention includes a plurality of service access points (SAPs) 441 to 446, each of which forms an interface between the protocol layers 410 to 430, the control plane agent 110, and the user plane agent 120. SAPs 444 and 445 of the plurality of SAPs 441 to 446 correspond to control service access points (c-SAPs), which are control interfaces. As shown in FIG. 2, each layer is divided by the respective SAPs 441 to 443. In addition, a Node-B+ boundary is provided as an interface between a base station supporting the protocol architecture of the present embodiment and the control plane agent 110 and the user plane agent 120.

The control plane 500 includes a PHY layer 410, a MAC+ layer 421, and an N-RRC layer 431, and the user plane includes the PHY layer 410 and the MAC+ layer 421.

Referring to FIG. 2, control plane (C-plane) signaling is processed through the N-RRC layer 431, the MAC+ layer 421, and the physical layer 410, and user plane (U-plane) information is processed through the MAC+ layer 421 and the physical layer 410.

The physical layer 410 is the lowest layer in the protocol architecture, and transmits/receives packet data to/from a radio channel by using a physical layer technique of a wireless communication system that the terminal 300 can access. The physical layer 410 provides an information transmission service by using radio transfer technology, and is connected to the data link layer 420 through a transport channel. The transport channel is defined by the way of data processing in the physical layer. The physical layer 410 protocol according to the exemplary embodiment of the present invention may use an orthogonal frequency division multiplexing (OFDM) scheme, which is a new technology provided for a high-speed data service having wideband channel characteristics. The OFDM scheme is appropriate for a complex multi-path environment, and enables an adaptive frequency control. In addition, the physical layer 410 may use a third generation access technique such as a wideband Code Division Multiple Access (WCDMA), which is an existing wideband cellular technology, or another physical layer technology, such as wideband cellular technology or local area network access technology.

The data link layer 420 is located above the physical layer 410 and performs a mapping function, and a primitive and parameter conversion function. The data link layer 420 according to the exemplary embodiment of the present invention controls a protocol by using one protocol stack rather than multiple protocol stacks, wherein the protocol performs a resource access control, a wireless link control, and a radio resource control in a wireless local area network (LAN) access technology in an ad-hoc mode and an infrastructure mode, a wideband cellular technology, and a next generation wireless transmission technology. In addition, the data link layer 420 performs various functionality blocks in a single layer such that latency within the terminal protocol can be reduced and an inter-layer signaling process and a peer-to-peer signaling process can be simplified. The data link layer 420 includes the MAC+ layer 421. The MAC+ layer 421 includes functions of a media access control (MAC) layer that performs mapping between a logical channel and a transport channel in the protocol architecture of the conventional cellular system and functions of a radio link control (RLC) layer that guarantees reliable data transmission. The data link layer 420 and the network layer 430 are connected through the logical channels.

The network layer 430 includes a network protocol for various core networks 100 that the terminal 300 can access when a user of the terminal 300 moves from one place to another. As shown in FIG. 2, the network layer 430 according to the exemplary embodiment of the present invention includes an N-RRC layer 431 that handles only radio resource management for establishing a radio bearer, and establishing and releasing access between the terminal 300 and the core network 100 so as to distinguish an operation mode and a communication state of the terminal 300.

The N-RRC layer 431 manages radio resource allocation, and the physical layer 410 transmits packet data to a radio channel by using a radio resource allocated by the N-RRC layer 431. In addition, the MAC+ layer 421 according to the present invention may distribute a shared resource or a shared channel according to a quality of service (QoS) required by a terminal or user data. At this time, the physical layer 410 transmits packet data to a radio channel by using the shared resource distributed by the MAC+ layer 421. Herein, the shared resource represents a resource that can be entirely or partially allocated to a terminal as a dedicated resource upon a request of the terminal.

Transmission of data in the user plane 600, and particularly, the SAP 443 between the data link layer 420 and the network layer 430 may be operated in a transparent mode (TM), an acknowledged mode (AM), and an unacknowledged mode (UM). Data is transmitted without being additionally processed under the TM, data is transmitted after eliminating errors therein by using an automatic repeat request (ARQ) method in the AM, and data is transmitted after checking whether there is an error therein in the UM.

The c-SAPs 444 and 445 respectively provided between the network layer 430, the data link layer 420, and the physical layer 410 transmit channel condition information and channel setting control information based on the channel condition information. Particularly, the present embodiment provides a new mapping method between a logical channel and a transmission channel by using the c-SAP 445 between the data link layer 420 and the physical layer 410.

Functions performed by the upper layers 420 and 430 in the protocol architecture according to the exemplary embodiment of the present invention will now be described in more detail.

As shown in FIG. 2, the MAC+ layer 421 of the data link layer 420 provides media access control functionality and logical link control functionality in a radio interface, and also supports data communication through data packet exchange between the user plane agent 120 of the core network 300 and the terminal 300.

The data link layer 420 performs mapping between the logical channel and the transport channel based on control information transmitted from the network layer 430 or channel information collected through the physical layer 410. At this time, the data link layer 420 determines and performs switching in mapping between a specific logical channel and a common transport channel (CTCH) and between a shared transport channel (STCH) and a dedicated transport channel (DTCH). Herein, a control command and radio channel quality information (CQI) are transmitted through the c-SAP 445 provided between the data link layer 420 and the physical layer 410.

Although it has been described in the present embodiment that the data link layer 420 determines switching of a channel type, the network layer 430 may switch the type of a transport channel mapped with a specific logical channel by exchanging information through the c-SAP 445 provided between the network layer 430 and the physical layer 410.

The data link layer 420 schedules data packets transmitted from the core network 100 and outputs the scheduled data packets through the physical layer 410. At this time, when a plurality of terminals 300 communicate with the base station 210 by using one common channel (CCH) or a random access channel (RACH), the data link layer 420 additionally allocates a terminal identifier to each terminal such that the data link layer 420 performs the packet scheduling on the basis of the identifier. Herein, identifier information is inserted between header information and payload information of the data packet and transmitted through the data packet, and the base station multiplexes data transmission to transport channels by using the identifier information transmitted in the data packet. In addition, the data link layer 420 controls the amount of frame transmission between the terminal 300 and the base station 210 so as to process a frame with efficient speed. Accordingly, the data link layer 420 processes a response signal (i.e., AK, NACK) and manages a transmission buffer.

The data link layer 420 transmits transport blocks multiplexed from a protocol data unit (PDU) of the upper layer to the physical layer 410. The physical layer 410 transmits the transport blocks to the CTCH and the STCH. The CTCH includes a forward access channel (FACH) set to the transport block and a multimedia broadcast/multicast service channel (MCH). The data link layer 420 receives data packets transmitted to the physical layer 410 through the transport channel, and demultiplexes the packets and transmits the demultiplexed packets to the upper layers.

The data link layer 420 performs traffic volume measurement and controls state transition of the terminal 300 that supports the protocol architecture of FIG. 2 for an efficient use of the shared transport channel with respect to the radio resources. In addition, the data link layer 420 ciphers data to be transmitted by adding the data to be transmitted and an encryption mask in bits so as to protect the data from malicious users. At this time, the encryption can be performed in all the user data transmission modes supported by the data link layer 420. That is, the encryption can be performed in the TM mode, AM mode, and UM mode.

The data link layer 420 determines a data transmission mode depending on a QoS class of the user data transmitted through the physical layer 410, and selects an access service class for a random access channel.

The data link layer 420 performs functions of an RLC protocol. That is, the data link layer 420 performs segmentation, reassembly, concatenation, and padding on a packet. Particularly, when peer-to-peer data transmission is performed under the AM mode, the data link layer 420 corrects transmission error by using an automatic repeat request (ARQ) retransmission scheme such as selective repeat, go back n, stop-and-wait, and hybrid automatic repeat request (ARQ). Then, the data link layer 420 checks a sequence number, and thus when the transmission is failed, the data link layer 420 discards an SDU and informs the transmission failure to a receiving side. When a protocol error occurs, the data link layer 420 operates a RESET procedure to reset an AM MAC+ entity in the receiving side.

The network layer 430 may be divided into a control plane and a user plane, and the control plane of the network layer 430 includes a radio resource control (RRC) protocol. Particularly, the network layer 430 of the base station 210 performs a function of an RRC protocol of a radio resource controller in a conventional radio access network. That is, the network layer 430 establishes, reestablishes, and releases a radio bearer between the terminal 300 and the radio access network 200. In addition, the network layer 430 provides an RRC connection and a signaling connection for control information exchange between the terminal 300 and the radio access network 200, and establishes and releases the bearer and the connections by using radio channel information transmitted from the terminal 300 through the bearer.

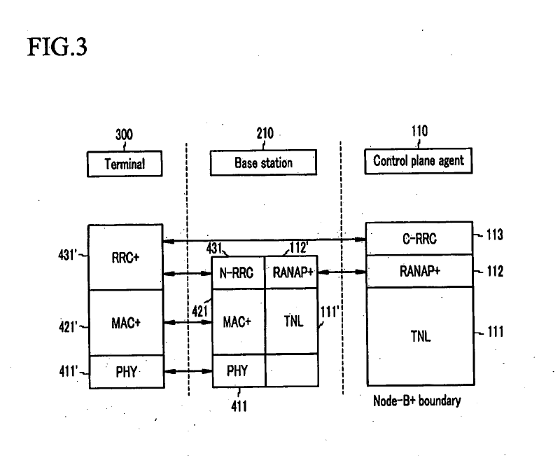

FIG. 3 shows a control plane in protocol architecture of the wireless communication system in the cellular system according to the exemplary embodiment of the present invention.

As shown in FIG. 3, a control plane agent 110 according to an exemplary embodiment of the present invention performs a function that used to be performed in a control plane of a packet switching support node and a mobility management function that used to be performed by the radio resource controller of the conventional radio access network, and includes a transport network layer (TNL) 111, a radio access network application part (RANAP) 112, and a C-RRC layer 113.

The TNL layer 111 supports transmission of upper layer data. The RANAP 112 is a signaling protocol for managing a radio resource between the radio access network 200 and the core network 100, and handles overall controls such as a burst control or error recovery and provides notification related to a call of a specific terminal or all terminals and a dedicated control signaling for transmission of control information related to the specific terminal. The RANAP 112 may encapsulate an upper layer signaling message, and the encapsulated message is transparently transmitted through the Node-B+ boundary. The C-RRC layer 113 allows the mobility management function, which used to be performed by the radio resource controller of the conventional radio access network, to be performed in the control plane of the core network. The C-RRC 113 protocol supports session management and a short message service.

The control plane agent 110 supporting the above-stated protocol architecture is connected to a plurality of base stations 210 and controls mobility of the terminal 300 and packet session management.

As shown in FIG. 3, the base station 210 according to the exemplary embodiment of the present invention supports the protocol architecture of FIG. 2. In addition, the base station 210 includes a TNL layer 111′ and a RANAP 112′ and performs protocol conversion for signal exchange with the control plane agent 110 so that the terminal 300 and the core network 100 can exchange information. In the case that the terminal 300 receives a request for establishing and modifying a radio access bearer (RAB) from the core network 100 through the Node-B+ boundary, the terminal 300 analyzes an available resource and determines whether to accept or reject the request based on the analysis.

The terminal 300 supports the protocol shown in FIG. 2 and thus includes a physical layer protocol 411′, a MAC protocol 421′, and a radio resource control protocol 431′. Particularly, the radio resource control protocol 431′ includes a mobility support function and establishes a signaling radio bearer for signal exchange with a serving base station 210 that has been changed in accordance with a control signal transmitted from the control plane agent 110.

The terminal 300, the base station 210, and the control plane agent 110 of the cellular system having the control plane architecture of FIG. 3 perform peer-to-peer communication.

The Node-B+ boundary between the control plane agent 110 and the base station 210 supports a hand-off process performed by the control plane agent 110 between a plurality of base stations 210. That is, the Node-B+ boundary supports relocation of a serving base station and thus an RRC connection and a signaling connection provided from the RANAP can be moved from one base station 210 to another base station 210. In addition, the Node-B+ boundary supports a function that provides a geographical location of the terminal 300 for the core network 100 serving a location service, and provides a padding function. At this time, the Node-B+ boundary supports a signaling protocol so that the RANAP between the control plane agent 110 and the base station 210 can perform the above-stated functions through the Node-B+ boundary.

Since the base station 210 in the cellular system according to the exemplary embodiment of the present invention performs functions that used to be performed by the RLC and RRC protocols, signaling overhead between the terminal 300 and the core network 100 of the cellular system can be reduced. That is, the reduction of the signaling overhead reduces latency of the control plane in the base station 210. Since signaling overhead during dynamic control is caused by an internal signal of the base station 210, the latency of the control plane can be reduced thereby enabling efficient and close inter-layer operation. In addition, a QoS scheduler and a radio resource management function exist in one base station 210 and therefore changes in a radio channel and in a QoS per data flow can be efficiently handled.

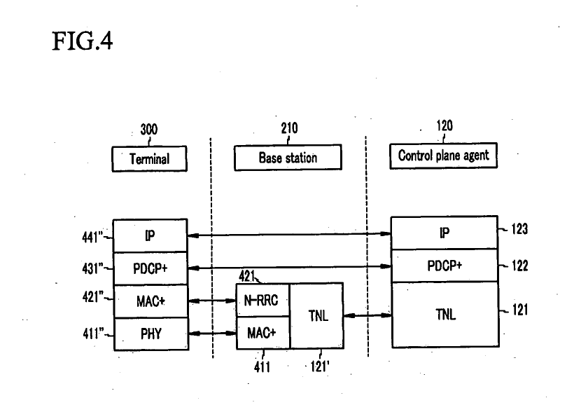

FIG. 4 shows a protocol stack of a user plane in the wireless communication system according to the exemplary embodiment of the present invention.

As shown in FIG. 4, the user plane agent 120 according to the exemplary embodiment of the present invention supports data communication through data packet exchange between the terminal 300 and the core network 100. The user plane agent 120 performs a function of a packet data convergence protocol (PDCP) that supports functions performed by a user plane of a serving general packet radio service (GPRS) support node (SGSN) and a user plane of a gateway GPRS support node (GGSN) and supports packet transmission by compressing an IP packet header and transmitting the compressed result. The user plane agent 120 includes a TNL layer 121, a PDCP layer 122, and a packet data protocol (PDP) layer 123. FIG. 4 shows the case of using an Internet protocol (IP) layer 123 as the PDP layer.

The TNL layer 121 supports transmission of data from the base station 210 to upper layers. The PDCP layer 122 supports upper layer protocols such as a point-to-point protocol, an Internet Protocol version 4 (IPv4), and an Internet Protocol version 6 (IPv6) in a radio interface, and transmits packets. In addition, the PDCP layer 122 performs IP header compression so as to increase packet data transmission efficiency, and manages a sequence number to protect data loss during relocation of the base station 210, and maintains data transmission order for an upper layer protocol. When handover occurs due to movement of the terminal 300 and thus the PDCP layer 122 receives a plurality of duplicate packet data from a base station, the PDCP layer 122 performs selection or combination. Through the selection or combination, a macro-diversity can be obtained. The IP layer 123 controls a packet transmission path between heterogeneous networks depending on an IP address to thereby enable communication between the heterogeneous networks.

The PDCP layer 122 according to the exemplary embodiment of the present invention classifies user data received from the packet data protocol layer 123 in accordance with a quality of service (QoS) and provides the user data to the MAC+ layer 421 together with classification information. According to the present embodiment, this is because that the MAC+ layer 421 may refer to the QoS of the packet data protocol layer 123, but it is difficult for the MAC+ layer 421 to perceive a QoS of user data due to the existence of the PDCP layer 122 between the MAC+ layer 421 and the packet data protocol layer 123.

As shown in FIG. 4, the protocol architecture of the base station 210 corresponds to the user plane 600 of the protocol architecture of FIG. 2, and the TNL layer 121′ is additionally included to perform protocol conversion for signal exchange with the user plane agent 120 such that the terminal 300 and the core network 100 can communicate data with each other.

The user plane of the terminal 300 sequentially includes a physical layer 411″, a MAC+ layer 421″, a PDCP layer 431″, and an IP layer 441″ for data communication with the base station 210 and the user plane agent 120. Herein, the physical layer 411″ is the lowest layer.

Data communication in the cellular system having the above-stated configuration will now be described. The base station 210 establishes a PDP context, exchanges packet data with the control plane agent 110 through tunneling, and performs IP routing. In addition, the base station 210 establishes a mobility management context for the terminal 300, generates a PDP context for routing through PDP context activation, and performs protocol data unit exchange between the terminal 300 and the user plane agent 120 based on information included in the PDP context. The MAC+ layer 411 of the base station 210 assembles data packets transmitted from the terminal 300 and transmits the assembled data packets to the user plane agent 120. At this time, the base station 210 changes an adaptive modulation and coding (AMC) option in accordance with radio channel condition variation and performs segmentation on packets in accordance with the amount of data transmission such that a header size and packet processing latency can be reduced and an automated repeat request (ARQ) can be efficiently processed.

In the present exemplary embodiment, the AMP option is changed in accordance with the radio channel condition and thus a plurality of protocol data units transmitted in the same transmission time interval (TTI) containing the same information can be prevented, thereby achieving an efficient use of resource in the radio interface.

The user plane agent 120 may support macro-diversity between a plurality of base stations 210, and thus, segments of the transmitted data packets are assembled in the terminal 300.

With the above-stated configuration, overhead due to frequent data transmission between the conventional base station and the radio resource controller can be reduced, and accordingly, a signaling overhead in the control plane due to the data transmission overhead can also be reduced.

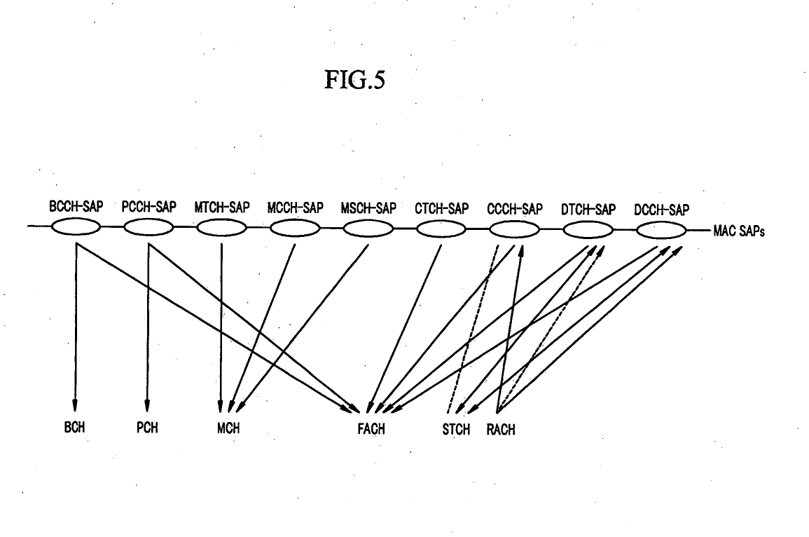

FIG. 5 shows mapping between the logical channel and the transport channel of the cellular system according to the exemplary embodiment of the present invention. In FIG. 5, the mapping between the logical channel and the transport channel is performed through a service access point from the base station side. In the embodiment of the present invention, a transmission channel is additionally defined without changing the types of a MAC-SAP used for mapping between a logical channel and a transport channel in the conventional 3GPP system.

As shown in FIG. 5, the cellular system according to the exemplary embodiment of the present invention provides logical channels such as a broadcast control channel (BCCH), a paging control channel (PCH), a common traffic channel (CTCH), a common control channel (CCCH), a dedicated traffic channel (DTCH), a dedicated control channel (DCCH), an MBMS point-to-multipoint traffic channel (MTCH), an MBMS point-to-multipoint scheduling channel (MSCH), and an MBMS point-to-multipoint control channel (MCCH). The cellular system also provides transport channels such as a broadcast channel (BCH), a paging channel (PCH), an MBMS channel (MCH), a shared traffic channel (STCH), and a random access channel (RACH). Mapping between the logical channel and the transport channel in the base station 210 is controlled by the MAC+ layer 421 or the N-RRC layer 431 of the control plane 500.

The BCCH that transmits system information (SI) required for communication between the terminal 300 and the core network 100 is mapped to the BCH, and the PCCH that transmits paging information to a user for notification of a communication request from the core network 100 is mapped to the PCH. In addition, the cellular system according to the exemplary embodiment of the present invention maps the MTCH, the MCCH, and the MSCH to the MCH and transmits MBMS receiving information and MBMS data in accordance with MBMS service receiving order that has been determined on the basis of a result of scheduling a plurality of users through an additional transmission channel dedicated to the MBMS. The MTCH, MCCH, and MSCH are logical channels for multimedia broadcast and multicast services. The DTCH, DCCH, and CCCH are mapped to the STCH, and a channel (DCH) dedicated to one terminal for the DTCH and DCCH is not provided in the present exemplary embodiment of the present invention. The DTCH is a bi-directional, point to point channel, dedicated to one terminal for transmitting user information, the DCCH is a bi-directional, dedicated channel used to carry dedicated channel information between the core network 100 and a user, and the CCCH is a bi-directional channel used to transmit control information to a user terminal that does not have a dedicated channel. The CCCH, DTCH, and DCCH are mapped to the RACH, and a plurality of terminals 300 can perform contention-based data transmission through the RACH. In addition, the BCCH, PCCH, CTCH, CCCH, DTCH, and DCCH are mapped to a forward access channel (FACH), which is a common downlink channel performing an open-loop power control and supports a relatively small amount of data transmission to the terminal 300.

The above-described exemplary embodiment of the present invention may be realized by an apparatus and a method, but it may also be realized by a program that realizes functions corresponding to configurations of the exemplary embodiment or a recording medium that records the program.

Such a realization can be easily performed by a person skilled in the art.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

[Advantageous Effects]

Accordingly, latency of the control plane and the user plane between the base station and the terminal can be reduced according to the above-described embodiment of the present invention. In addition, the data unit segmentation is performed in accordance with the AMC option, and therefore, packet data overhead is reduced, thereby achieving an efficient use of radio resources.

1. A wireless communication system comprising:
a network layer for receiving user data from an upper layer;
a data link layer for determining a data transmission mode on the basis of a qualify of service (QoS) of the user data and segmenting the user data into a plurality of packet data;
a physical layer for transmitting the plurality of packet data to a radio channel; and
a control service access point for transmitting control information between the data link layer and the physical layer.

2. The wireless communication system of claim 1, wherein the network layer manages radio resource allocation and the physical layer transmits the plurality of packet data through an allocated resource among the radio resources.

3. The wireless communication system of claim 2, wherein the data link layer manages shared resource distribution among the radio resources, and the physical layer transmits the plurality of packet data through a distributed resource among the shared resources.

4. The wireless communication system of claim 3, wherein the data link layer manages the shared resource distribution on the basis of a QoS required for the user data.

5. The wireless communication system of one of claim 1 to claim 4, wherein the network layer classifies the user data in accordance with a QoS and transmits the user data to the data link layer together with classification information.

6. The wireless communication system of one of claim 1 to claim 4, wherein the data link layer selects one transmission mode for data transmission among a transparent mode, an acknowledged mode, and an unacknowledged mode based on the QoS required for the user data for data transmission.

7. The wireless communication system of one of claim 1 to claim 4, wherein the physical layer estimates a radio channel condition, and the data link layer determines an adaptive modulation and coding (AMC) based on the radio channel condition and segments the user data in accordance with the determined AMC option.

8. The wireless communication system of claim 7, wherein the physical layer and the data link layer are connected through a plurality of transport channels, and the data link layer and the network layer are connected through a plurality of logical channels.

9. The wireless communication system of claim 8, wherein the data link layer controls mapping between the plurality of logical channels and the plurality of transport channels in accordance with the radio channel condition estimated in the physical layer.

10. The wireless communication system of claim 9, wherein the data link layer receives radio channel condition information and transmits channel mapping information through the control service access point.

11. The wireless communication system of claim 10, wherein the physical layer supports an MBMS channel and a shared transport channel (STCH), wherein the MBMS channel is a bi-direction channel for providing a multimedia broadcast/multicast service (MBMS) to the terminal and the STCH is a bi-direction channel shared by a plurality of terminals.

12. The wireless communication system of claim 11, wherein the data link layer maps a plurality of logical channels for providing MBMS to the MBMS channel.

13. The wireless communication system of claim 12, wherein the logical channels for providing the MBMS comprise an MBMS point-to-multipoint traffic channel (MTCH), an MBMS point-to-multipoint scheduling channel (MSCH), and an MBMS point-to-multipoint control channel (MCCH).

14. The wireless communication system of claim 11, wherein the data link layer maps a dedicated control channel (DCCH) and a dedicated traffic channel (DTCH) to the STCH.

15. A wireless communication system comprising:
a physical layer for receiving a plurality of packet data from a radio channel and estimating a condition of the radio channel;
a data link layer for assembling the plurality of received packet data;
a network layer for providing the assembled packet data to upper layers; and
a control service access point for transmitting control information between the data link layer and the physical layer.

16. The wireless communication system of claim 15, wherein the network layer performs selection when the network layer receives a plurality of duplicate packet data that have been assembled in the data link layer from the data link layer as the same data due to an occurrence of handover.

17. The wireless communication system of claim 15, wherein the network layer performs combination when the network layer receives a plurality of duplicate packet data that have been assembled in the data link layer from the data link layer as the same data due to an occurrence of handover.

18. The wireless communication system of claim 15 to claim 17, wherein the network layer receives user data from upper layers;
the data link layer determines an adaptive modulation and coding (AMC) based on the radio channel condition and segments the user data in accordance with the determined AMC option; and
the physical layer transmits the plurality of packet data transmitted from the data link layer to the radio channel.

19. The wireless communication system of claim 18, wherein the network layer manages radio resource allocation and the physical layer transmits the plurality of packet data to the radio channel through an allocated resource among radio resources.

20. The wireless communication system of claim 19, wherein the data link layer manages shared resource distribution among the radio resources, and the physical layer transmits the plurality of packet data through a distributed resource among the shared resources.

21. The wireless communication system of claim 20, wherein the data link layer manages the shared resource distribution on the basis of a QoS required for the user data.
